(19) United States
(12) Patent Application Publication
(10) Pub. No.: US 2020/0331050 A1
(43) Pub. Date: Oct. 22, 2020

(54) HIGH TEMPERATURE SUSTAINABLE Zn-Ni COATING ON STEEL SUBSTRATE

(71) Applicants: THE UNIVERSITY OF WESTERN ONTARIO, LONDON, ON (CA); MARWOOD INTERNATIONAL INC., TILLSONBURG, ON (CA)

(72) Inventors: JUN YANG, LONDON, ON (CA); ZHIFENG DING, LONDON, ON (CA); MAHDI HESARI, LONDON, ON (CA); PATRICK THERRIEN, KOMOKA, ON (CA); QIUQUAN GUO, LONDON, ON (CA); DARRIN OGLAN, WINDSOR, ON (CA)

(21) Appl. No.: 16/755,210

(22) PCT Filed: Oct. 10, 2018
(86) PCT No.: PCT/CA2018/051277

§ 371 Date: Apr. 10, 2020

Related U.S. Application Data
(60) Provisional application No. 62/571,006, filed on Oct. 11, 2017.

(51) Int. Cl. B21D 22/02; B32B 15/01; C25D 3/56; C25D 5/36

(52) U.S. Cl. CPC B21D 22/022; B32B 15/015; C25D 5/36; C25D 3/562; C25D 3/565

(57) ABSTRACT

The present disclosure provides a one pot process for co-electrodeposition of Zn—Ni layers on steel substrates involving pretreating a steel substrate and then immersing the steel substrate into an aqueous electrolyte containing at least salts of Ni and Zn with the salts of Ni and Zn being present in concentrations to give a ratio of Ni to Zn in a range from about 1:1 to about 1000:1, the aqueous electrolyte including a buffer to give the aqueous electrolyte a pH in a range from about 3 to about 6. This is followed by electroplating a Zn—Ni layer onto the steel substrate by applying a voltage between the steel substrate as cathode and an anode electrode also immersed in the aqueous electrolyte, the applied voltage being selected to give a current density in a range from about 8 mA/mm2 to about 50 mA/mm2. The electroplating is performed with the aqueous electrolyte heated to a temperature in a range from about 20° C. to about 50° C.

### FIELD

The present disclosure relates to high temperature sustainable Zn—Ni coatings on steel substrates and method of producing this coating.

### BACKGROUND

Nickel and its alloys are one of the most popular mechanically stable coatings that have been widely used as a protecting layer on different substrates. Ultrahigh-strength steels are increasingly used in automotive industry due to their high strength and light weight properties, which could not only increase the fuel efficiency resulting in decreasing of carbon footprint, but also meet the crash safety requirements. The industrial application of this technology in car body production just started in the early nineties. In 2009 already more than 110 hot stamping production lines were in service and still their number is increasing. For example Volekswagen is increased the Ultrahigh-strength steel usage from 6% to 28% in the past few years. It is projected that the global demand for hot stamped ultrahigh-strength steel parts will exceed 600 million per year by 2050. The current invention can address the oxidation problem of ultrahigh strength steels during hot stamping and keep their unique properties.

Currently, hot dipped aluminized coatings are produced industrially to serve as a protective coating, such as Usibor 1500P, which is the only commercially available coated ultrahigh strength steel developed by Arcelor. However, this Al—Si coating layer does not provide an effective protection for the substrate against oxidation at high temperature. The coating also results in cracks or ablations during large deformations. Also, the Al—Si (90/10%) coated steel has a lower temperature resistance (up to 800° C.), while the proposed Zn—Ni coating can feasibly heated up to 950° C. without any cracks on the coating surface.

### SUMMARY

The present disclosure relates to a controllable Zn—Ni alloy coating on ultrahigh strength steel deposited by electroplating, which can effectively provide both mechanical and chemical protections on the steel substrate against oxidation during the entire high-temperature hot stamping process in air. The coating also sustains intact after stamping and contains a high content of Ni is this coating. This disclosure provides a method for applying an optimal Zn—Ni coating to ultrahigh strength steel with optimal coating thickness and composition.

The present disclosure provides a one-pot electroplating process for depositing a Zn—Ni alloy coating with the composition of the Zn—Ni alloy being controlled over a wide composition range by controlling the electroplating process, in particular with the Ni atomic percentage >23%. The present disclosure provides a low Ni content in the Zn—Ni alloys (typically in the range of 12-15%). Furthermore, it can protect the ultrahigh strength steel substrate against oxidation during high-temperature (up to 950° C.) hot stamping.

By controlling the electrical current (>8 mA/mm²), deposition potential, (0.4-0.9 V) deposition time, electrolyte concentration, pH, temperature and surface treatment, high-quality, dense, uniform Zn—Ni alloy coating is obtained. The desired microstructure, density, interfacial adhesion strength with the substrate, can be obtained by the optimized electroplating process. Due to the high quality of the coating, a thin Zn—Ni coating (7-19 microns) can provide sufficient protection during hot-stamping, and also show excellent ductility.

The present disclosure provides a one pot process for co-electrodeposition of Zn—Ni layers on steel substrates, comprising:

a) pretreating a steel substrate and then immersing the steel substrate into an aqueous electrolyte containing at least salts of Ni and Zn with the salts of Ni and Zn being present in concentrations to give a ratio of Ni to Zn in a range from about 1:1 to about 1000:1, the aqueous electrolyte including a buffer to give the aqueous electrolyte a pH in a range from about 3 to about 6;

b) electroplating a Zn—Ni layer onto the steel substrate by applying a voltage between the steel substrate as cathode and an anode electrode also immersed in the aqueous electrolyte, the applied voltage being selected to give a current density in a range from about 8 mA/mm² to about 50 mA/mm²; and

c) the electroplating being performed with the aqueous electrolyte heated to a temperature in a range from about 20° C. to about 50° C.

The applied voltage may be selected to give a current density in a range from about 10 mA/mm² to about 30 mA/mm².

The applied voltage may be selected to give a current density in a range from about 12 mA/mm² to about 20 mA/mm².

The applied voltage may be selected to give a current density of about 15 mA/mm².

The aqueous electrolyte may further include any one or combination of potassium chloride (KCl), sodium chloride (NaCl) and potassium nitrate (KNO₃).

The salt of Ni may include any one or combination of nickel chloride (NiCl₂) and nickel nitrate (NiNO₃).

The salt of Zn may include any one or combination of zinc chloride (ZnCl₂), and zinc nitrate (ZnNO₃).

The buffer may be boric acid (H₃BO₃).

The step a) of pretreating the steel substrate may include
first polishing the steel substrate surface to be coated followed by immersing the steel substrate into an alkaline solution for removing residual contaminations from the polished steel surface; and
immersing the steel substrate into an acidic solution comprising hydrochlorid acid (HCl) and ammonium bifuoride (NH₄HF₂) for activating the steel surface to be coated for electrodeposition.

The present disclosure provides a process of hot stamping a steel substrate, comprising:

co-electrodepositing a Zn—Ni layer on the steel substrate using the process described above to produce a coated steel substrate; and

subjecting the coated steel substrate to hot stamping.

A further understanding of the functional and advantageous aspects of the present disclosure can be realized by reference to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1: shows photographs of coatings of different Zn/Ni molar percentages coated on steel sample, before (top row) and after (bottom row) heat treatment. The percentage ratio of Zn/Ni varies as follow: 50, 20, 10, 5, 3, 1, 0.5, 0.25 and 0.1% M. The electrodeposition bath composition is [H₃BO₃]=0.5 M, [KCl]=0.5 M, and j=25 mA/cm², T=25° C.

FIG. 2: panel (A) Cross sectional and (B) top view SEM images of Zn—Ni-coated O1 steel before heat treatment. Panels (C) and (D) show the coating thickness and texture after heat treatment. The inset in panel (B) shows the higher resolution of the top view image of the coated surface. Electrodeposition conditions; [Ni²⁺]=0.5 M, [Zn²⁺]=2.5×10⁻³M (% Zn−Ni=0.5) [H₃BO₃]=0.5 M, [KCl]=0.5 M, j=25 mA/cm², T=25° C.

FIG. 3: shows SEM-EDX spectra of Zn—Ni coated steel samples before (A) and after (B) heat treatment at 930° C. for 5 minutes. The Au peaks indicate gold coating used for SEM imaging.

FIG. 4: shows thin film XRD spectra of Zn—Ni coated steel samples before (A) and after (B) heat treatment at 930° C. for 5 minutes.

FIG. 5: shows dynamic secondary ion mass spectrometry (Dynamic SIMS) spectra of Zn—Ni coated steel samples before panel (A) and after panel (B) heat treatment at 930° C. for 5 minutes with both panels (A) and (B) identifying the different detected elements.

FIG. 6: shows XPS survey spectra of Zn—Ni coated steel samples before panel (A) and after panel (B) heat treatment at 930° C. for 5 minutes with both panels (A) and (B) identifying the different detected elements.

FIG. 7: shows photographs of part coated with Zn—Ni, before panel (A) and after panel (B) heat treatment. Panel (B) also shows a section of coated/uncoated part that cut for surface analysis.

### DETAILED DESCRIPTION

Various embodiments and aspects of the disclosure will be described with reference to details discussed below. The following description and drawings are illustrative of the disclosure and are not to be construed as limiting the disclosure. The drawings are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

As used herein, the phrase “one pot process” means a co-deposition process of both Ni and Zn in one bath.

As used herein, the phrase “steel substrates” means uncoated or bare steel plates. These types of steels are uncoated and have little or no resistance against oxidation and/or corrosion processes. These coatings can be used to protect steel substrates provide a sustainable protection on the surface.

The present process provides a one pot process for co-electrodeposition of Zn—Ni layers on steel substrates. The steel substrate is first pretreated which may first polishing the steel substrate surface to be coated followed by immersion into an alkaline solution for removing residual contaminations from the polishing of the steel surface. The substrate may then be immersed into an acidic solution comprising hydrochlorid acid (HCl) and ammonium bifuoride (NH₄HF₂) for activating the steel surface to be coated for electrodeposition. It will be appreciated that many possible pretreatment steps may be employed to clean the steel surface and then condition it for electrodeposition.

After the pretreatment step, the steel substrate is then immersed into an aqueous electrolyte containing at least salts of Ni and Zn with the salts of Ni and Zn being present in concentrations to give a ratio of Ni to Zn in a range from about 1:1 to about 1000:1. The aqueous electrolyte includes a buffer to give the aqueous electrolyte a pH in a range from about 3 to about 6. A Zn—Ni layer is then electroplated onto the steel substrate by applying a voltage between the steel substrate as cathode and an anode electrode also immersed in the aqueous electrolyte with the applied voltage being selected to give a current density in a range from about 8 mA/mm² to about 50 mA/mm². The electroplating is performed with the aqueous electrolyte heated to a temperature in a range from about 20° C. to about 50° C.

In a preferred embodiment of the process, the applied voltage is selected to give a current density of about 15 mA/mm².

In embodiments the aqueous electrolyte may further include any one or combination of potassium chloride (KCl), sodium chloride (NaCl) and potassium nitrate (KNO₃).

In embodiments the salt of Ni includes any one or combination of nickel chloride (NiCl₂) and nickel nitrate (NiNO₃). The salt of Zn includes any one or combination of zinc chloride (ZnCl₂), and zinc nitrate (ZnNO₃).

In an embodiment the buffer is boric acid (H₃BO₃).

The present process will now be illustrated with the following non-limiting examples.

### Experimental

### Chemicals.

Nickel chloride, boric acid, zinc chloride, and potassium chloride were purchased from Aldrich. Hydrochloric acid provided by Caledon, Canada. Deionized (DI) water used to prepare the solutions. Nickel plate bought from Caswell Inc., cut in 2.5×3.5 cm size and used as the anode electrode. The O1 steel substrates purchased from Starrett (Oil hardening precision ground flat stock) with 0.12×1.27×91.4 cm, and cut to 1.27×2 cm sample pieces. Each sample polished with grit 600 (P1200) Silicon Carbide grinding paper (Buehler Met® II), rinsed with an alkaline solution (Coventya Inc.), and ultrasonicated in DI water for 2×2 min. Finally, the steel sample(s) ultrasonicated in % 25 v/v HCl contain 30 g/L ammonium bifluoride solution for 30 sec., and dried before the electroplating process. Solutions of Ni²⁺ and Zn²⁺ contain H₃BO₃ (0.5 M) and KCl (0.5 M) was used as coating electrolyte in which different Zn concentrations (% Zn in Ni=50, 20, 10, 5, 3, 1, 0.1, 0.5 and 0.25) was used A two-electrode electrochemical system used for the electroplating the steel substrates. For heating experiments the samples were placed in an open-end quartz tube, and temperature were held at 930° C. for 5 minutes.

### Instrumentation

A PAR model 273 potentiotat/galvanostat was used for electroplating process. Samples heating were conducted using an electrical heating furnace (Lindberg blue M, thermo scientific, Canada). Scanning Electron Microscopy coupled with Energy Dispersive X-ray (SEM-EDX) Spectroscopy of the samples performed using a Hitachi S-4500 field emission SEM with a Quartz PCI XOne SSD X-ray analyzer. All SEM images captured applying 10 keV. A Cameca IMF-6f SIMS used to run Dynamic Secondary Ion Mass Spectrometry (D-SIMS) experiments. X-ray Photoelectron Spectroscopy (XPS) analyses of the samples were performed using a Kratos AXIS Ultra Spectrometer.

### Results and Discussion

### Zinc-Nickel Coating on Steel Substrate.

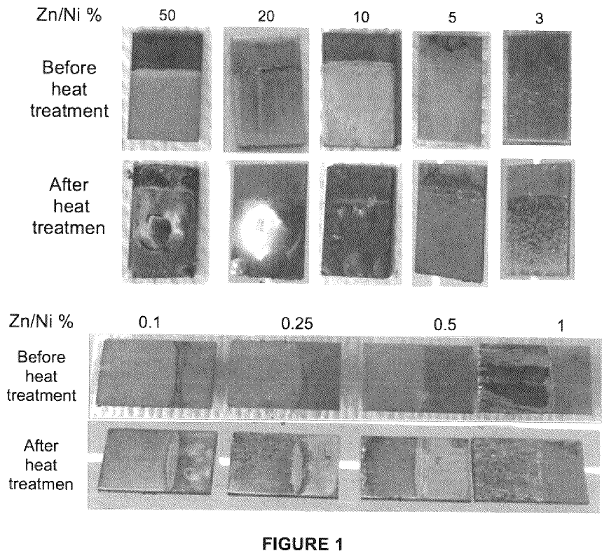

The electrochemical deposition conditions (e.g. [Zn^{2'}]/[Ni²⁺]) for Zn—Ni coating on O1 steel sample were optimized. The Zinc-nickel coating showed a significant advantage over many other coatings such as nickel. This is mainly due to the presence of zinc as an anti-corrosive element, while the nickel coating provides the hardness on the coated surface. We prepared different zinc to nickel molar (Zn—Ni) electrolytes including 50, 20, 10, 5, 3, 1, 0.5, 0.25 and 0.1%. The samples were coated following recipe; [Ni²⁺]=0.5 M, [H₃BO₃]=0.5 M, [KCl]=0.5 M, [Zn²⁺]=0.25, 0.1, 5×10⁻², 2.5×10⁻², 1.5×10⁻², 5×10⁻³, 2.5×10⁻³, 12.5×10⁻³, 5×10⁻⁴ M. The coating quality and stability were examined before and after heat treatment. For example, 50, 20, 10, 5 and 3% Zn—Ni coatings did not provide homogenous coatings either before or after heat treatment at 930° C. (FIG. 1). It is worth mentioning that the most instability of coating with high percent of Zn, originates from boiling point of Zn at 907° C., which is lower than our heating temperature (930° C.). By increasing the Ni content in the coating electrolyte, after heat treatment experiments more stable coatings were obtained.

The bottom row of FIG. 1 shows coated steel sample with 1, 0.5, 0.25 and 0.1% M of Zn—Ni electrolytes. In the different coating, the one with %1 Zn—Ni did not provide a good coating, while it can be noticed that the other coated samples show more stable layers before and after heat treatment.

Basically, the coating needs lower ration of Zn rather than Ni. This provides a good mechanical stability of the coating along with enough percentage of Zn (as a sacrificial element) to passive the coating layer from oxidation under high temperature and pressure during stamping process.

The content of Zn in the coatings examined using SEM-EDX technique and the obtained results were compared with Zn—Ni diagram phase (Table 1). It can be seen that the zinc content is proportional to the bulk [Zn], for the same current density and deposition time. In theory the highest content of [Zn] in the coating is more desirable. Thus, the %0.5 M Zn/Ni with the %2.3 Zn was chosen as the optimized electrolyte and further structural and elemental analyses was performed.

TABLE 1
SEM-EDX elemental analysis of different Zn—Ni
coated samples before heat treatment.

| | % at | | | | |
|---|---|---|---|---|---|
| % Zn—Ni | C | O | Fe | Ni | Zn |
| 0.50 | 43.3 | 3.1 | 0.9 | 50.4 | 2.3 |
| 0.25 | 27 | 2.3 | 1.2 | 69 | 0.9 |
| 0.10 | 45.1 | 3.6 | 0.7 | 49.3 | 1.3 |

SEM Surface Imaging Before and after Heat Treatment.

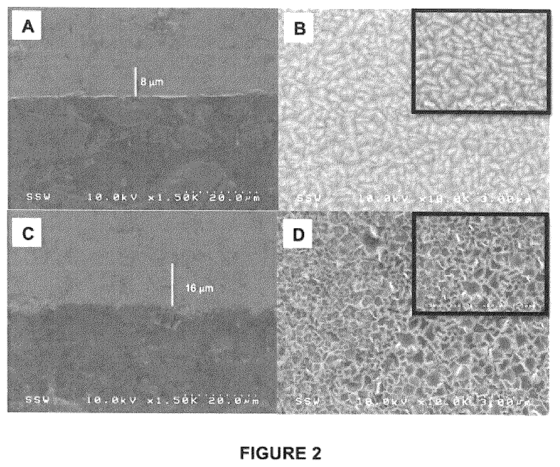

FIG. 2 shows SEM images of Zn—Ni coated O1 steel using [Ni²⁺]=0.5 M, [Zn²⁺]=2.5×10⁻³M (% Zn/Ni=0.5) [H₃BO₃]=0.5 M, [KCl]=0.5 M, j=25 mA/cm². The coated thickness layer was measured to be 8 μm, with a closed packed star-shaped texture (panel A and B). This is basically because of high content of nickel in the coating. Panel (C) of FIG. 2 shows a cross-sectional SEM images of Zn—Ni coated after heat treatment, where the thickness of the coating is almost doubly increased. There is also significant change in the coating texture as shown in panel (D). The high temperature caused expansions of the coating, followed by formation of opened textures in the coating.

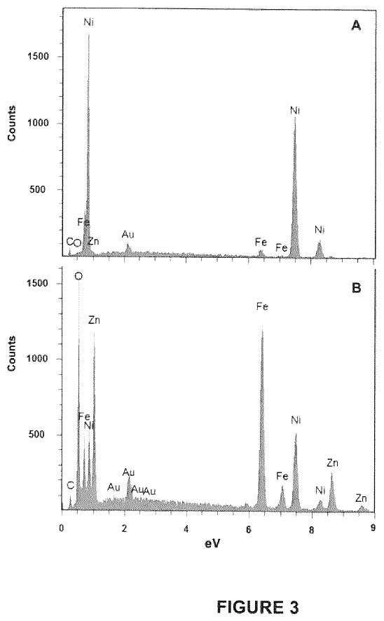

FIG. 3 shows SEM-EDX graphs of the Zn—Ni coated steel samples before panel (A) and after panel (B) heat treatment. The EDX data for the coated sample before heat treatment show a strong peak for Ni as the dominant element in the coating, along with small peaks for iron and zinc. Interestingly, after heat treatment, strong peaks for zinc and iron are well detected that could be due to either expansion of the closed-packed coating, or elemental migration of these elements from the basic coating layer and the heated substrate and mixing at the surface. There is also an enhancement in the oxygen peak, which is due to the oxidation of the coating during the heat treatment.

The SEM-EDX of the substrate before and after heat treatment was performed in order to determine if the coated steel substrate also oxidized after heat treatments at high temperature. The results showed that the oxygen content of both samples showed no changes for before and after heating at that 930° C., proving the protection property of the coating on the steel substrate against oxidation process.

It is noted that the atomic percentage of oxygen in both samples are very similar and there is no increase in the oxygen content after the heating process. Although, the Zn—Ni coating layer was oxidized, the main substrate stayed intact.

The Zn—Ni coating was further investigated using different techniques such as X-ray diffraction, dynamic secondary ion mass spectrometry, and X-ray photoelectron spectroscopy.

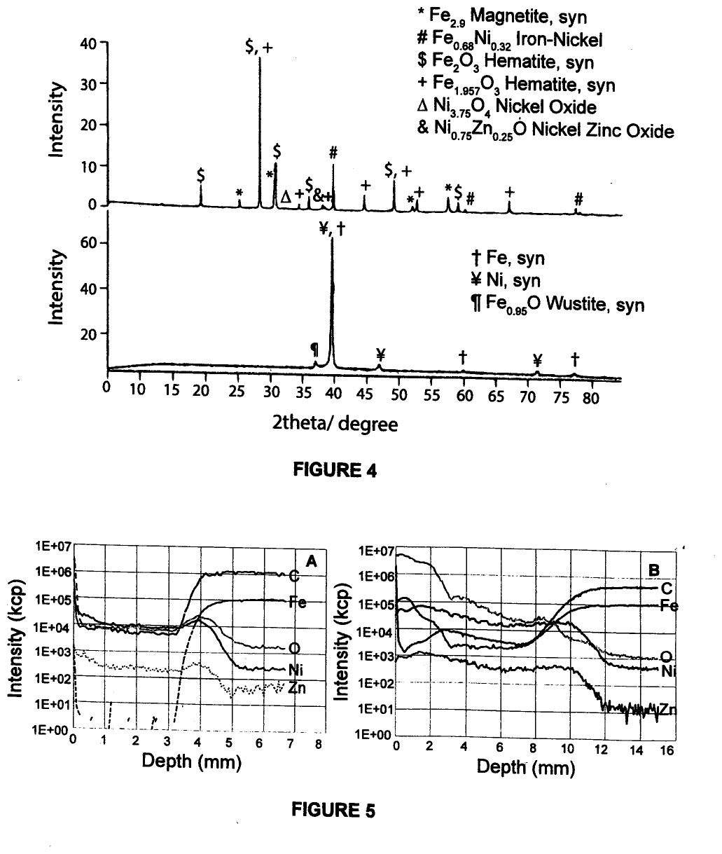

X-ray diffraction helps to better understand binary phase transformation(s) of the coating before and after heat treatment processes. FIG. 4 represents XRD spectra of Zn—Ni coated steel samples before (black curve) and after (red curve) heat treatment at 930° C. The XRD spectrum of the unheated coated sample shows peaks at 44.9, 52.0, 76.5 degree indication of nickel (PDF 00-004-0850). The iron content shows peaks at 44.9, 64.8, 82.2 degree (PDF 04-007-9753). The XRD spectrum of the heated coated sample shows several peaks corresponding to various components consist of: Fe_{1.975}O₃ (Hematite, syn, PDF 01-077-9926), Fe_{2.9}O₄ (Magnetite, syn, PDF 04-009-2285), Fe_{0.68}Ni_{0.32} (iron-nickel, PDF 04-004-5110), Fe₂O₃ (Hematite, syn, PDF 04-003-2900), and Ni_{3.75}O₄ (nickel oxide, PDF 04-007-0510). As can be seen in FIG. 4, there are various oxides, formed in the course of the heat treatment along with nickel-iron and nickel-zinc alloys. It is worth commenting on the XRD patterns before and after heat treatment, as it causes significant changes in the appearance many new peaks.

FIG. 5 shows dynamic SIMS spectra of Zn—Ni coated steel samples before and after heat treatment experiments. As can be seen in panel A, in the first 3 microns of the coating the top layer is basically consist of nickel, oxygen, carbon and zinc. Importantly, the coating is thick enough 4 microns) to protect the steel substrate, while by increasing the sampling depth iron signal was detected.

After performing the heat treatment on the sample panel (B), the oxygen element is detected first as it is the main component of all the possible metal oxides (e.g., Fe₂O₃, NiO). Interestingly, nickel is the second element on the coating layer. The iron and carbon, the two main components of the substrate were detected next, as they can migrate through the coating layer during the heating process. It is important to note that, zinc-coating stays at the base of the coating, which is an essential element to provide anti-corrosion property of the coating. By increasing the sampling depth (e.g., 10 microns), the substrate basic elements comes up and show the highest intensity, indicating an estimation on the thickness expansion of the coating after heat treatment process.

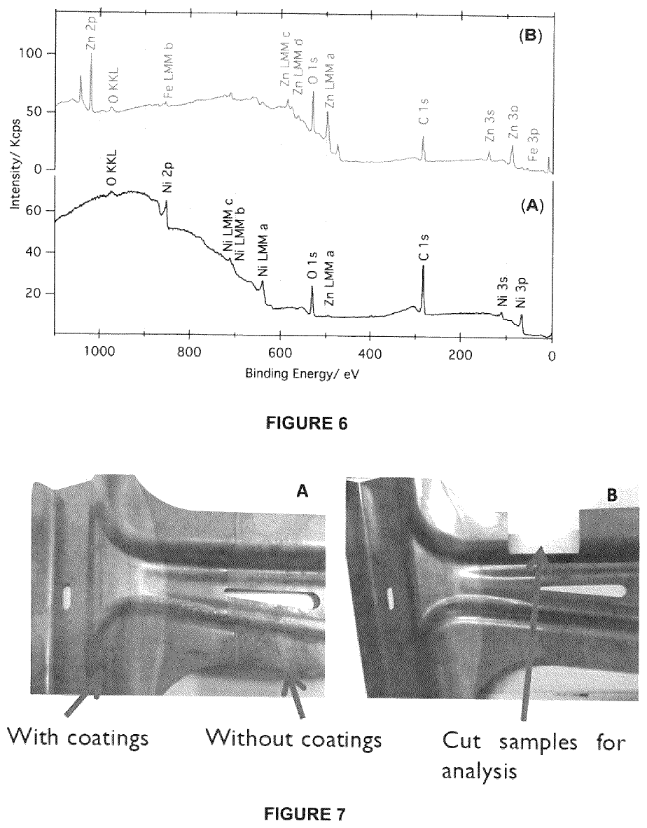

Further elemental surface analysis was performed using X-ray photoelectron spectroscopy (XPS) in the Zn—Ni coated samples before and after heat treatment process. FIG. 6 shows the XPS surveys of the Zn—Ni coated O1 steel before and after treatment at 930° C. In panel (A) the XPS spectrum of the coated sample before treatment is shown, in which corresponding peaks for Ni (3s, 3p, LMMa, LMMb, LMMc, 2p)¹, C (1s), O (1s, KLL) and Zn (LMMa)² are detected. Panel B represents the XPS spectrum of the same coating after keeping at 930° C. for 5 minutes. The heating process causes changing in the XPS spectrum features with appearance peaks assigned for zinc and iron that were migrated from the bottom of the coating to the surface and mixed with each other to form the alloys. As a results a clear peaks for Zn (3p, 3s, LMMb, LMMc, LMMd, and 2p),² and Fe (3p, LMMb) were detected in the heated sample surface.

To examine our coating recipe a steel piece half-coated and hot stamped to make a vehicle body part. FIG. 7 panel (A) shows the coated piece in which a half of sample Zn—Ni coated and the second half is the original steel material (indicated as without coating). As indicated in the image, the coated part has stable smooth features and the coating did not peel off after applying high temperature and pressure in the course of stamping process. A piece of this sample, in which both coated and un-coated areas are included, was cut for surface sample analysis as indicated in panel (B).

### CONCLUSION

In summary, the present inventors have coated the surface of steel with Zn—Ni alloy using electrochemical deposition in boric acid solution. The obtained coating revealed stable adhesion before and after heating at 930° C. The SEM surface analysis showed that the well-packed metallic coating changes to an opened pattern texture upon heating, while still the steel substrate is protected against oxidation. The dynamic SIM technique also showed that the heating process causes migration coating elements thought the coating and form a mixed alloy system. Thin film XRD and XPS reveled a different patterns before and after heating process. This proves that Zn—Ni coating can be successfully utilized to coat a steel surface as an anti-oxidation protection.

### REFERENCES

1. M. C. Biesinger, B. P. Payne, A. P. Grosvenor, L. W. M. Lau, A. R. Gerson and R. S. C. Smart, App. Surf. Sci., 257, 2717 (2011).
2. M. C. Biesinger, L. W. M. Lau, A. R. Gerson and R. S. C. Smart, App. Surf. Sci., 257, 887 (2010).

1. A one pot process for co-electrodeposition of Zn—Ni layers on steel substrates, comprising:
a) pretreating a steel substrate and then immersing the steel substrate into an aqueous electrolyte containing at least salts of Ni and Zn with the salts of Ni and Zn being present in concentrations to give a ratio of Ni to Zn in a range from about 1:1 to about 1000:1, the aqueous electrolyte including a buffer to give the aqueous electrolyte a pH in a range from about 3 to about 6;
b) electroplating a Zn—Ni layer onto the steel substrate by applying a voltage between the steel substrate as cathode and an anode electrode also immersed in the aqueous electrolyte, the applied voltage being selected to give a current density in a range from about 8 mA/mm² to about 50 mA/mm²; and
c) the electroplating being performed with the aqueous electrolyte heated to a temperature in a range from about 20° C. to about 50° C.

2. The process according to claim 1, wherein the applied voltage is selected to give a current density in a range from about 10 mA/mm² to about 30 mA/mm².

3. The process according to claim 1, wherein the applied voltage is selected to give a current density in a range from about 12 mA/mm² to about 20 mA/mm².

4. The process according to claim 1, wherein the applied voltage is selected to give a current density of about 15 mA/mm².

5. The process according to claim 1 wherein the aqueous electrolyte further includes any one or combination of potassium chloride (KCl), sodium chloride (NaCl) and potassium nitrate (KNO₃).

6. The process according to claim 1, wherein the salt of Ni includes any one or combination of nickel chloride (NiCl₂) and nickel nitrate (NiNO₃).

7. The process according to claim 1, wherein the salt of Zn includes any one or combination of zinc chloride (ZnCl₂), and zinc nitrate (ZnNO₃).

8. The process according to claim 1, wherein the buffer is boric acid (H₃BO₃).

9. The process according to claim 1, wherein the step a) of pretreating the steel substrate includes
first polishing a surface of the steel substrate to be coated followed by immersing the steel substrate into an alkaline solution for removing residual contaminations from the polished surface; and
immersing the steel substrate into an acidic solution comprising hydrochlorid acid (HCl) and ammonium bifuoride (NH₄HF₂) for activating the surface of the steel substrate to be coated for electrodeposition.

10. A process of hot stamping a steel substrate, comprising:
co-electrodepositing a Zn—Ni layer on the steel substrate using the process of claim 1, to produce a coated steel substrate; and
subjecting the coated steel substrate to hot stamping.
